(19) United States
(12) Patent Application Publication
(10) Pub. No.: US 2025/0130799 A1
(43) Pub. Date: Apr. 24, 2025

(54) TECHNIQUES FOR PERFORMING NON-VECTOR MICRO-OPERATIONS ON VECTOR HARDWARE

(71) Applicant: Ampere Computing LLC, Santa Clara, CA (US)

(72) Inventors: Christopher PALISTRANT, Portland, OR (US); Willard BRIGGS, Boulder, CO (US); Carl E. LEMONDS, JR., Indian Land, SC (US); Benjamin Crawford CHAFFIN, Portland, OR (US)

(21) Appl. No.: 18/490,680

(22) Filed: Oct. 19, 2023

(51) Int. Cl. G06F 9/30; G06F 9/38

(52) U.S. Cl. CPC G06F 9/30036; G06F 9/3836; G06F 9/3856

(57) ABSTRACT

Disclosed are techniques for processing non-vector micro-operations. In an aspect, a micro-operation processing apparatus may include a first execution unit configured to execute micro-operations and a second execution unit configured to execute micro-operations. The micro-operation processing apparatus may include a first multiplexer having an output operatively coupled to an input of the second execution unit. The micro-operation processing apparatus may include a first data input lane operatively coupled to an input of the first execution unit and a first input of the first multiplexer. The micro-operation processing apparatus may also include a second data input lane operatively coupled to a second input of the first multiplexer.

### BACKGROUND OF THE DISCLOSURE

### 1. Field of the Disclosure

Aspects of the disclosure relate generally to performing micro-operations on hardware for processing units.

### 2. Description of the Related Art

An instruction set architecture (ISA) is part of the abstract model that defines how a processing unit, such as a central processing unit (CPU) executes software. The ISA defines the set of hardware operations that the software may perform, specifying both what the processing unit is capable of doing as well as how it gets done.

A vector architecture is generally optimal for certain workloads that can be decomposed into vector instructions having vectors of data elements, where one or a few instructions will be applied repetitively to the entire vector of data elements. Vector processing hardware may improve performance, for example, on workloads involving numerical simulations and like tasks and accordingly are used in various processing units.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a micro-operation processing apparatus may include a first execution unit configured to execute micro-operations; a second execution unit configured to execute micro-operations; a first multiplexer having an output operatively coupled to an input of the second execution unit; a first data input lane operatively coupled to an input of the first execution unit and a first input of the first multiplexer; and a second data input lane operatively coupled to a second input of the first multiplexer. In some cases, the first execution unit and the second execution unit are configured to cooperatively execute a vector micro-operation. In some cases, at least one of the first execution unit or the second execution unit is configured to execute a non-vector micro-operation.

In an aspect, a method may comprise processing a vector micro-operation using a first execution unit of a core processor and a second execution unit of the core processor. In some cases, the first execution unit and second execution unit together form a vector micro-operation execution unit. The method may also comprise starting a first non-vector micro-operation using the first execution unit after the vector micro-operation has completed.

In an aspect, a processing unit may include one or more memories; and one or more processors communicatively coupled to the one or more memories, the one or more processors, either alone or in combination, may be configured to process a vector micro-operation using a first execution unit of a core processor and a second execution unit of the core processor. In some cases, the first execution unit and second execution unit together form a vector micro-operation execution unit. The one or more processors, either alone or in combination, may be configured to start a first non-vector micro-operation using the first execution unit after the vector micro-operation has completed.

In an aspect, a processing unit includes means for processing a vector micro-operation using a first execution unit of a core processor and a second execution unit of the core processor. In some cases, the first execution unit and second execution unit together form a vector micro-operation execution unit. The processing unit also includes means for starting a first non-vector micro-operation using the first execution unit after the vector micro-operation has completed.

In an aspect, a non-transitory computer-readable medium stores computer-executable instructions that, when executed by a processing unit, cause the processing unit to process a vector micro-operation using a first execution unit of a core processor and a second execution unit of the core processor. In some cases, the first execution unit and second execution unit together form a vector micro-operation execution unit. The computer-executable instructions, when executed by a processing unit, may also cause the processing unit to start a first non-vector micro-operation using the first execution unit after the vector micro-operation has completed.

In an aspect, a method comprises processing a first vector micro-operation using a first execution unit of a core processor and a second execution unit of the core processor. In some cases, the first execution unit and second execution unit together form a vector micro-operation execution unit for performing vector micro-operation having a first bit width. The method may also comprise starting a second vector micro-operation using the first execution unit after the vector micro-operation has completed. In some cases, the second vector micro-operation has a second bit width less than the first bit width.

In an aspect, a processing unit includes one or more memories; and one or more processors communicatively coupled to the one or more memories, the one or more processors, either alone or in combination, configured to process a first vector micro-operation using a first execution unit of a core processor and a second execution unit of the core processor. In some cases, the first execution unit and second execution unit together form a vector micro-operation execution unit for performing vector micro-operation having a first bit width. The one or more processors, either alone or in combination, may be configured to start a second vector micro-operation using the first execution unit after the vector micro-operation has completed. In some cases, the second vector micro-operation has a second bit width less than the first bit width.

In an aspect, a processing unit includes means for processing a first vector micro-operation using a first execution unit of a core processor and a second execution unit of the core processor. In some cases, the first execution unit and second execution unit together form a vector micro-operation execution unit for performing vector micro-operation having a first bit width. The processing unit may also include means for starting a second vector micro-operation using the first execution unit after the vector micro-operation has completed. In some cases, the second vector micro-operation has a second bit width less than the first bit width.

In an aspect, a non-transitory computer-readable medium stores computer-executable instructions that, when executed by a processing unit, cause the processing unit to process a first vector micro-operation using a first execution unit of a core processor and a second execution unit of the core processor. In some cases, the first execution unit and second execution unit together form a vector micro-operation execution unit for performing vector micro-operation having a first bit width. The computer-executable instructions, when executed by a processing unit, may cause the processing unit to start a second vector micro-operation using the first execution unit after the vector micro-operation has completed. In some cases, the second vector micro-operation has a second bit width less than the first bit width.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIGS. 1A and 1B illustrate examples of a processing unit, according to aspects of the disclosure.

FIG. 2A illustrates a first example hardware configuration of n-bit execution units in a processing unit, according to aspects of the disclosure.

FIG. 2B illustrates an example scheduling procedure associated with n-bit execution units in a processing unit, according to aspects of the disclosure.

FIG. 3 illustrates a second example hardware configuration of n-bit execution units in a processing unit, according to aspects of the disclosure.

FIG. 4A illustrates an example micro-operations processing apparatus including execution units that perform micro-operations in a processing unit, according to aspects of the disclosure.

FIG. 4B illustrates an example scheduling procedure associated with n-bit execution units in a processing unit, according to aspects of the disclosure.

FIG. 5 is an example timing diagram illustrating micro-operation processing techniques, according to aspects of the disclosure.

FIG. 6 is a flowchart of an example process for performing micro-operations in a processing unit, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects of the subject technology relate to techniques for performing micro-operations on vector hardware for non-vector micro-operations. Processing units with conventional vector hardware may experience low throughput when processing non-vector instructions (e.g., scalar divide instructions, square root instructions, etc.). That is, a core processor of a processing unit may include hardware that is optimized and configured for processing vector instructions. Vector processing may include processing pairs of data elements using multiple execution units during each clock cycle. Non-vector micro-operations may use a single data element during each clock cycle, and when performed with conventional vector hardware can be inefficient.

In some aspects, vector hardware on processing units may be configured with execution units that perform vector micro-operations cooperatively and non-vector micro-operations separately. In some examples, long latency non-vector micro-operations may be effectively processed by having each execution unit in a vector hardware configuration independently process a non-vector micro-operation. In some examples, additional components (e.g., multiplexers, gates, registers, etc.) may be added to a vector hardware configuration. In some aspects, the micro-operation processing apparatus and techniques described herein provide power savings and/or increased throughput when processing non-vector micro-operations on vector hardware configurations.

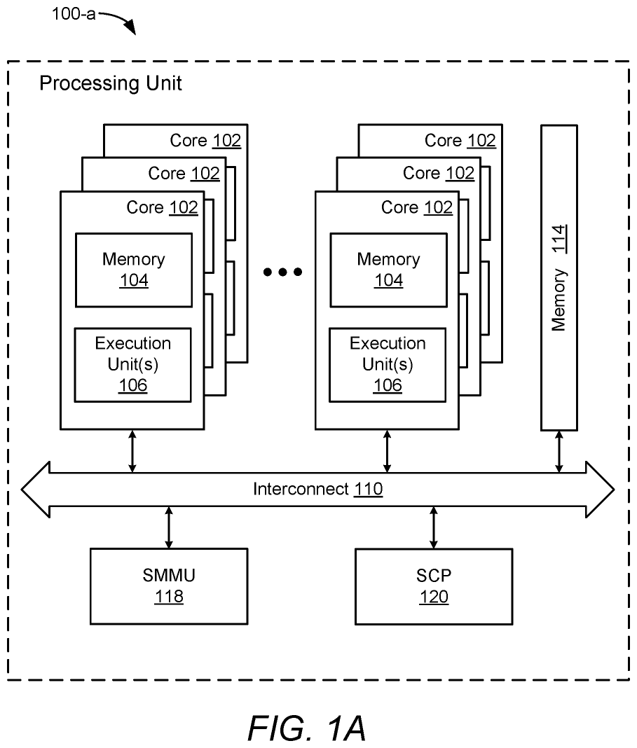

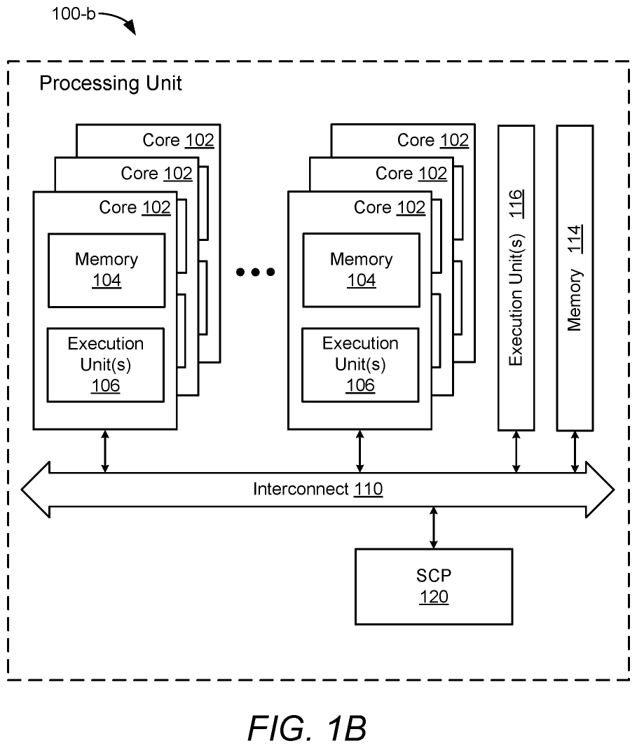

FIG. 1A illustrates a first example of a processing unit 100-a, according to aspects of the disclosure. In some examples, the techniques for performing non-vector operations on vector hardware described herein may be implemented using processing unit 100-a. Processing unit 100-a is configured as a central processing unit (CPU) but may also be used with or configured as other processing units, such as but not limited to a graphics processing (GPU) or tensor processing unit (TPU). Processing unit 100-a may include a set of processing cores 102 (or simply “cores” 102). Each core 102 may include memory 104 and one or more execution units 106. Each core 102 may be coupled to interconnect 110. In some examples, memory 104 may be configured as cache on the core 102 (e.g., 64 kB L1 Instruction-cache, 64 kB L1 Data-cache, and 1 MB L2 cache).

The one or more execution units 106 may perform various operations and calculations associated with instructions and operations of the core 102. The one or more execution units 106 may be configured as various units in the core 102 in accordance with various implementations. For example, the one or more execution units 106 may include arithmetic logic units (ALUs) that perform arithmetic and logic operations for the core 102. The one or more execution units 106 may include floating point units (FPUs) that perform floating point calculations. The one or more execution units 106 may include integer execution units (IXUs) for performing integer operations. The one or more execution units 106 may also include single instruction, multiple data (SIMD) execution units for performing various instructions. In some examples, an execution unit 106 may perform a combination of these and other operations. Each of the one or more execution units 106 may include a bus or interconnect, for example, to connect hardware elements of the execution units 106 to memory 104 to perform read and write functions while executing micro-operations.

Processing unit 100-a may also include memory 114, which may be coupled to interconnect 110. In some examples, memory 114 may include system-level cache (e.g., 32 MB) that may be used for various purposes by the processing unit 100-a. Processing unit 100-a may also include a system memory management unit (SMMU) 118, The SMMU 118 may provide translation services, for example, to non-processor master units. That is, for example, the SMMU 118 may translate addresses for direct memory address (DMA) requests from system input/output (I/O) devices before the requests are passed to interconnect 110. Processing unit 100-a may also include a system control processor (SCP) 120. The SCP 120 may be configured to handle various system management functions. In some examples, the SCP 120 may include separate microcontrollers (or processors). In some examples, the SCP 120 may be combined into one or two microcontrollers, or sub-divided into more than two microcontrollers in accordance with various implementations to handle various system management functions.

Interconnect 110 may be configured as a mesh interconnect that forms a high-speed interface that couples each of core 102 to the other cores 102 and other components in processing unit 100-a.

FIG. 1B illustrates a second example of a processing unit 100-b, according to aspects of the disclosure. In some examples, the techniques for performing non-vector operations on vector hardware described herein may be implemented using processing unit 100-b. Processing unit 100-b is configured as a CPU but may also be used with or configured as other processing units, such as but not limited to a GPU or TPU. Processing unit 100-b may include the components and features described with respect to processing unit 100-a in the example of FIG. 1A. In some cases, processing unit 100-b may include one or more execution units 116 that may be shared among the cores 102.

That is, for example, processing unit 100-b may include one or more execution units 116 such as ALUs, FPUs, IXUs, and/or SIMD execution units for all or a subset of the cores 102. In some examples of a processing unit, one or more of the components described herein with respect to FIGS. 1A and 1B may be omitted and other components may be included. For example, the SMMU 118 in the example of FIG. 1A is omitted in processing unit 100-b, and an alternative memory management unit associated with a different instruct set architecture (ISA) may be included.

It is to be appreciated that the processing unit 100-a of FIG. 1A and the processing unit 100-b of FIG. 1B may be configured according to a monolithic die design or a disaggregated chiplet design. That is, for example, in the monolithic die design, the cores 102, interconnect 110, memory 114, SMMU 118, and SCP 120 may be configured on a single die. In some cases, for example, in the disaggregated chiplet design, each chiplet of multiple disaggregated chiplets may include a subset of the cores 102 (e.g., in a tiled fashion) with a memory controller to control a portion of memory 114, and a peripheral component interconnect (PCI) or PCI express (PCIe) controller to control the interface with interconnect 110, SMMU 118, and/or SCP 120. Additionally, or alternatively, other computer architecture designs may be used in various implementations given the benefit of the teachings of the disclosure.

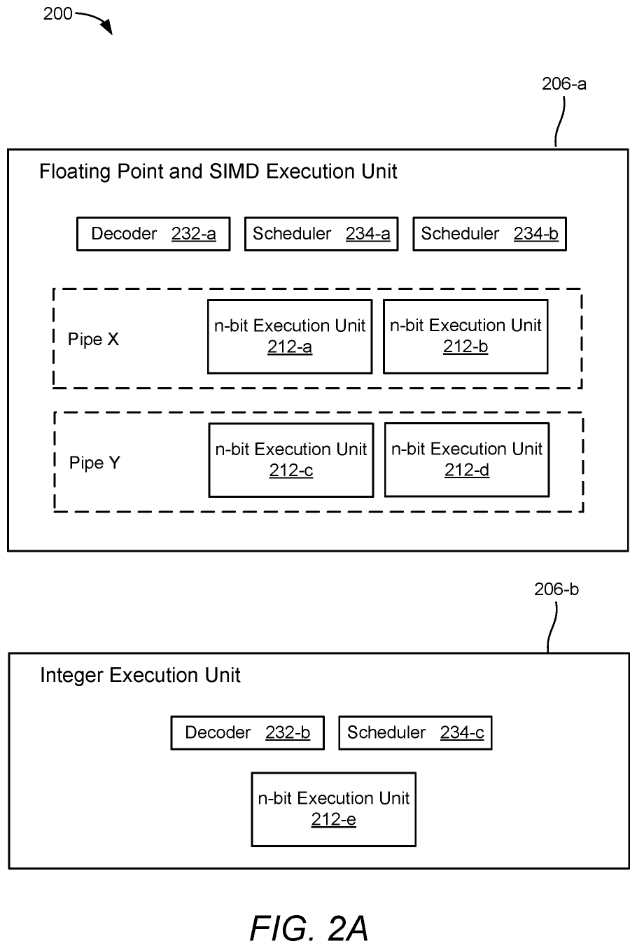

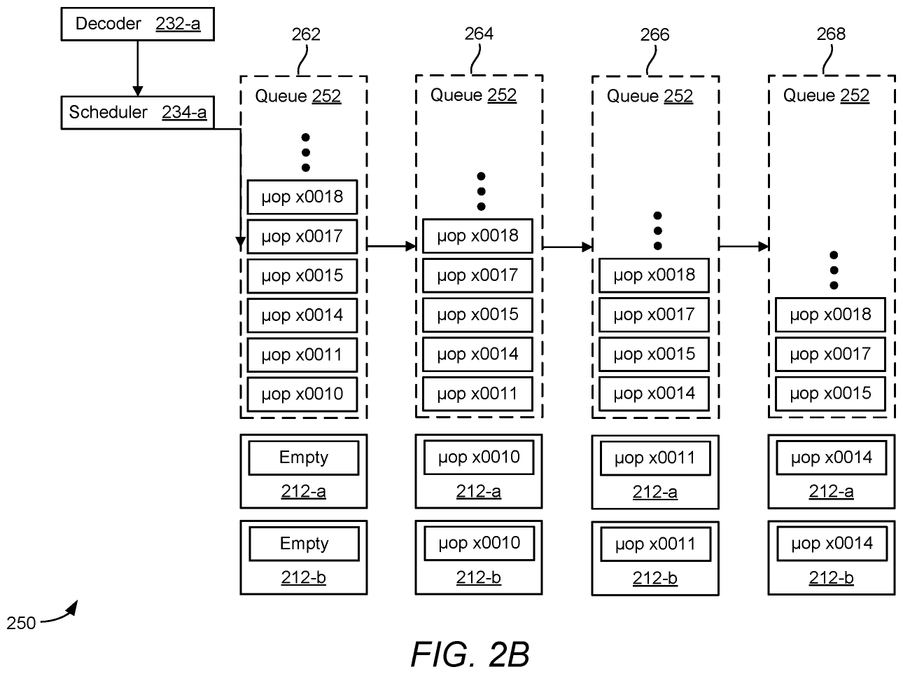

FIG. 2A illustrates a first example hardware configuration 200 of n-bit execution units 212 in a processing unit, according to aspects of the disclosure. In some examples, the techniques for performing non-vector operations on vector hardware described herein may be implemented using hardware configuration 200. One or more execution units in hardware configuration 200 may be implemented in various processing units. For example, one or more n-bit execution units 212 in hardware configuration 200 may be implemented in at least some of the one or more execution units 106 described with respect to processing unit 100-a in FIG. 1A or processing unit 100-b in FIG. 1B. Additionally, or alternatively, one or more n-bit execution units 212 in hardware configuration 200 may be implemented in at least some of the one or more execution units 116 described with respect to processing unit 100-b in FIG. 1B.

As illustrated in FIG. 2A, a floating point and SIMD execution unit (FSU) 206-a may include a first pipeline (e.g., Pipe X) and a second pipeline (e.g., Pipe Y). The first pipeline may include two execution units, a first n-bit execution unit 212-a and a second n-bit execution unit 212-b, and the second pipeline may also include two execution units, a first n-bit execution unit 212-c and a second n-bit execution unit 212-d. In some examples, the FSU 206-a may include its own decoders, schedulers, and memory, among other hardware elements. For example, the FSU 206-a may include a decoder 232-a. The decoder 232-a may be an instruction decode and rename (IDR) unit that receives instructions, decodes an instruction into micro-operations, and forwards the micro-operations to one of a first scheduler 234-a or a second scheduler 234-a. For example, scheduler 234-a may schedule and manage micro-operations for the first pipeline that includes the first n-bit execution unit 212-a and the second n-bit execution unit 212-b. Similarly, scheduler 234-b may schedule and manage micro-operations for the second pipeline that includes the first n-bit execution unit 212-c and the second n-bit execution unit 212-d.

FIG. 2B illustrates an example scheduling procedure 250 associated with n-bit execution units 212 in a processing unit, according to aspects of the disclosure. Referring to the examples of FIGS. 2A and 2B, when the first scheduler 234-a receives micro-operations from the decoder 232-a, the first scheduler 234-a may queue 252 the micro-operations before sending them to the first n-bit execution unit 212-a and the second n-bit execution unit 212-b for processing. That is, for example, each micro-operation may require a certain amount of time (e.g., number of clock cycles) to complete, and various micro-operations may require a longer time than others to complete. In some cases, the first scheduler 234-a queues the received micro-operations and sends them to the first n-bit execution unit 212-a and the second n-bit execution unit 212-b for processing in a first in, first out (FIFO) manner.

That is, for example, the first scheduler 234-a may sequentially receive and queue six micro-operations from the decoder 232-a: μop x0010, μop x0011, μop x0014, μop x0015, μop x0017, and μop x0018. In this example, the decoder 232-a may have forwarded μop x0012, μop x0013 and μop x0016 to the second scheduler 234-b, which may operate in a similar manner as described with respect to the first scheduler 234-a. Each of these six micro-operations forwarded to the first scheduler 234-a be vector micro-operations, for example.

For example, at 262, the first n-bit execution unit 212-a and the second n-bit execution unit 212-b may be empty and awaiting a micro-operation from the first scheduler 234-a. The first scheduler 234-a has a queue 252 including μop x0010, μop x0011, μop x0014, μop x0015, μop x0017, and pop x0018. When the first n-bit execution unit 212-a and the second n-bit execution unit 212-b are ready to receive a next micro-operation, at 264, the first scheduler 234-a may forward at μop x0010 to the first n-bit execution unit 212-a and the second n-bit execution unit 212-b for processing. At this time the first scheduler 234-a has a queue 252 including μop x0011, μop x0014, μop x0015, μop x0017, and μop x0018. At 266, after a first number of clock cycles in which the first n-bit execution unit 212-a and the second n-bit execution unit 212-b has completed μop x0010, the first scheduler 234-a may forward pop x0011 to the first n-bit execution unit 212-a and the second n-bit execution unit 212-b for processing. At this time, the first scheduler 234-a has a queue 252 including μop x0014, μop x0015, μop x0017, and μop x0018.

At 268, after a second number of clock cycles in which the first n-bit execution unit 212-a and the second n-bit execution unit 212-b has completed μop x0011 (e.g., a different number of clock cycles than used to complete pop x0010), the first scheduler 234-a may forward μop x0014 to the first n-bit execution unit 212-a and the second n-bit execution unit 212-b for processing. At this time the first scheduler 234-a has a queue 252 including μop x0015, μop x0017, and μop x0018. This FIFO may continue sequentially until μop x0018 has been scheduled and completed by the first n-bit execution unit 212-a and the second n-bit execution unit 212-b, in accordance with some examples.

That is, for example, the first n-bit execution unit 212-a and the second n-bit execution unit 212-b may operate together to perform various micro-operations, such as but not limited to vector floating point micro-operations. Some instructions received by decoder 232-a may be scalar instructions requiring scalar micro-operations, such as scalar floating point micro-operations to be scheduled by the first scheduler 234-a and executed. Thus, FSU 206-a may be tasked with performing these scalar instructions and other non-vector instructions using the first n-bit execution unit 212-a and the second execution unit 212-b. That is, for example, while FSU 206-a may be configured as vector hardware (e.g., with vector-optimized hardware elements and vector-sized registers in memory), this vector hardware configuration may also be tasked to perform scalar operations, which would be more efficiently performed using a scalar hardware configuration (e.g., a single instruction, single data (SISD) processor configurations) rather than a conventional vector hardware configuration. In some examples, FSU 206-a may be configured with vector hardware that utilizes techniques for performing non-vector (e.g., scalar) micro-operations as described herein. In some examples, FSU 206-a may be configured with vector hardware that utilizes techniques for performing different-sized vector micro-operations as described herein.

Additionally, hardware configuration 200 may include an integer execution unit (IXU) 206-b. The IXU 206-b may have a decoder 232-b, a scheduler 234-c, and a fifth n-bit execution unit 212-e. The IXU 206-b may be used for integer-specific micro-operations, such as integer divide micro-operations. That is, for example, the fifth n-bit execution unit 212-e (separate from the n-bit execution units 212 in FSU 206-a) may be dedicated for these integer-specific micro-operations.

In some implementations, one or more of the n-bit execution units 212 in hardware configuration 200 may be a 64-bit Radix 4 divide execution unit. That is, for example, the FSU 206-a may include two 64-bit Radix 4 divide execution units for each of the first pipeline and the second pipeline. In some cases, the first n-bit execution unit 212-a may be a first 64-bit Radix 4 divide execution unit, the second execution unit 212-b may be a second 64-bit Radix 4 divide execution unit, the third n-bit execution unit 212-c may be a third 64-bit Radix 4 divide execution unit, and the fourth execution unit 212-d may be a fourth 64-bit Radix 4 divide execution unit. In some cases, the two 64-bit Radix 4 divide execution units in each of the first and second pipelines of FSU 206-a may be used for 128-bit micro-operations.

Additionally, in some examples, the IXU 206-b may include a single 64-bit Radix 4 divide execution unit. That is, for example, the fifth n-bit execution unit 212-e may also be a 64-bit Radix 4 divide execution unit. In some cases, the single 64-bit Radix 4 divide execution unit in IXU 306-b may be used for 64-bit integer-specific micro-operations.

It is to be understood that, in some examples, the FSU 206-a and the IXU 206-b may be included for each core or may be shared among a plurality of cores in a processing unit, such as but not limited to processing unit 100-a or processing unit 100-b.

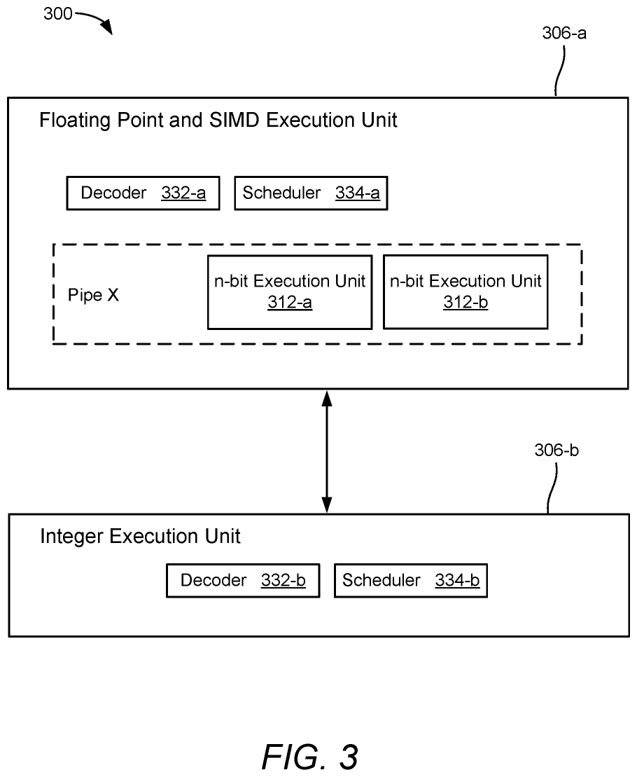

FIG. 3 illustrates a second example hardware configuration 300 of n-bit execution units 312 in a processing unit, according to aspects of the disclosure. In some examples, the techniques for performing non-vector operations on vector hardware described herein may be implemented using hardware configuration 300. One or more n-bit execution units 312 in hardware configuration 300 may be implemented in various processing units. For example, one or more n-bit execution units 312 in hardware configuration 300 may be implemented in at least some of the one or more execution units 106 described with respect to processing unit 100-a in FIG. 1A or processing unit 100-b in FIG. 1B. Additionally, or alternatively, one or more n-bit execution units 312 in hardware configuration 300 may be implemented in at least some of the one or more execution units 116 described with respect to processing unit 100-b in FIG. 1B. Some aspects described with respect to the example hardware configuration 200 may also be applicable to hardware configuration 300.

As illustrated in FIG. 3, an FSU 306-a may include a single pipeline (e.g., Pipe X). The single pipeline may include two execution units, a first n-bit execution unit 312-a and a second n-bit execution unit 312-b. In some examples, the FSU 306-a may include a decoder 332-a. The decoder 332-a may be an IDR unit that receives instructions, decodes an instruction into micro-operations, and forwards the micro-operations to a scheduler 334-a. For example, scheduler 234-a may schedule and manage micro-operations for the first n-bit execution unit 312-a and the second n-bit execution unit 312-b.

In some examples, when the scheduler 334-a receives micro-operations from the decoder 332-a, the first scheduler 234-a may queue the micro-operations before sending them to the first n-bit execution unit 312-a and the second n-bit execution unit 312-b for processing. Similar to the micro-operation processing described with respect to the example of FIG. 2A, the first n-bit execution unit 312-a and the second n-bit execution unit 312-b may operate together to perform various micro-operations.

In some examples, hardware configuration 300 may include an IXU 306-b. The IXU 306-b may have a decoder 332-b and a scheduler 334-b. While the IXU 306-b may include execution units for certain integer-specific micro-operations, the IXU 306-b may forward some integer-specific micro-operations, such as integer divide micro-operations to the FSU 306-a for processing. That is, for example, decoder 332-b may receive an integer divide instruction and may decode the instruction into one or more integer divide micro-operations. The decoder 332-b may forward the one or more integer divide micro-operations to the scheduler 334-b for scheduling. That is, for example, integer divide micro-operations may involve scalar quantities. In some cases, when the single pipeline of the FSU 306-a has a sufficiently high execution speed and/or the techniques for performing non-vector operations on vector hardware described herein are implemented in FSU 306-a, the scheduler 334-b or the IXU 306-b may forward the integer divide micro-operations to the FSU 306-a for processing.

That is, for example, the scheduler 334-b may receive a divide micro-operation, μop x0021, from the decoder 332-b. Based on μop x0021 being an integer divide micro-operation, the scheduler 334-b of IXU 306-b may forward pop x0021 to the scheduler 334-a of FSU 306-a for processing. In some cases, for example, when the single pipeline of the FSU 306-a has a sufficiently high execution speed, the scheduler 334-a may forward μop x0021 to the first n-bit execution unit 312-a and the second n-bit execution unit 312-b of the FSU 306-a for processing. In some cases, for example, when the techniques for performing non-vector operations on vector hardware described herein are implemented in FSU 306-a, the scheduler 334-a may forward pop x0021 to one of the first n-bit execution unit 312-a or the second n-bit execution unit 312-b of the FSU 306-a for processing. When the first n-bit execution unit 312-a, the second n-bit execution unit 312-b, or both complete pop x0021, the scheduler 334-a may forward the results back to the scheduler 334-b of IXU 306-b.

In some implementations, each of the n-bit execution units 312 in hardware configuration 300 may be a 64-bit Radix 16 divide execution unit. That is, for example, the FSU 306-a may include a first 64-bit Radix 16 divide execution unit and a second 64-bit Radix 16 divide execution unit. In some cases, the first 64-bit Radix 16 divide execution unit and the second 64-bit Radix 16 divide execution unit may be used for 128-bit micro-operations. In some implementations, a 64-bit Radix 16 divide execution unit may be approximately twice the size of a 64-bit Radix 4 divide execution unit but may have double the effective throughput. It is to be understood that, in some examples, the FSU 306-a and the IXU 306-b may be included for each core or may be shared among a plurality of cores in a processing unit, such as but not limited to processing unit 100-a or processing unit 100-b.

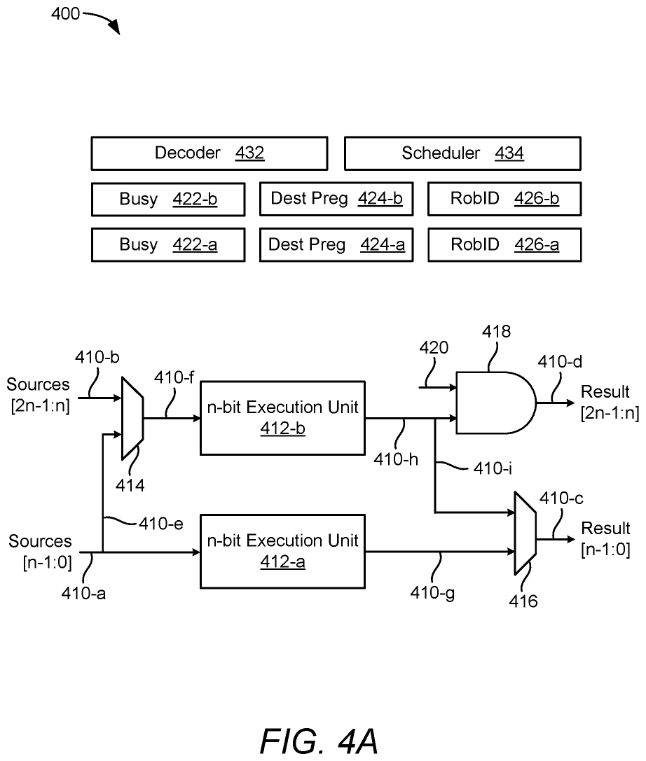

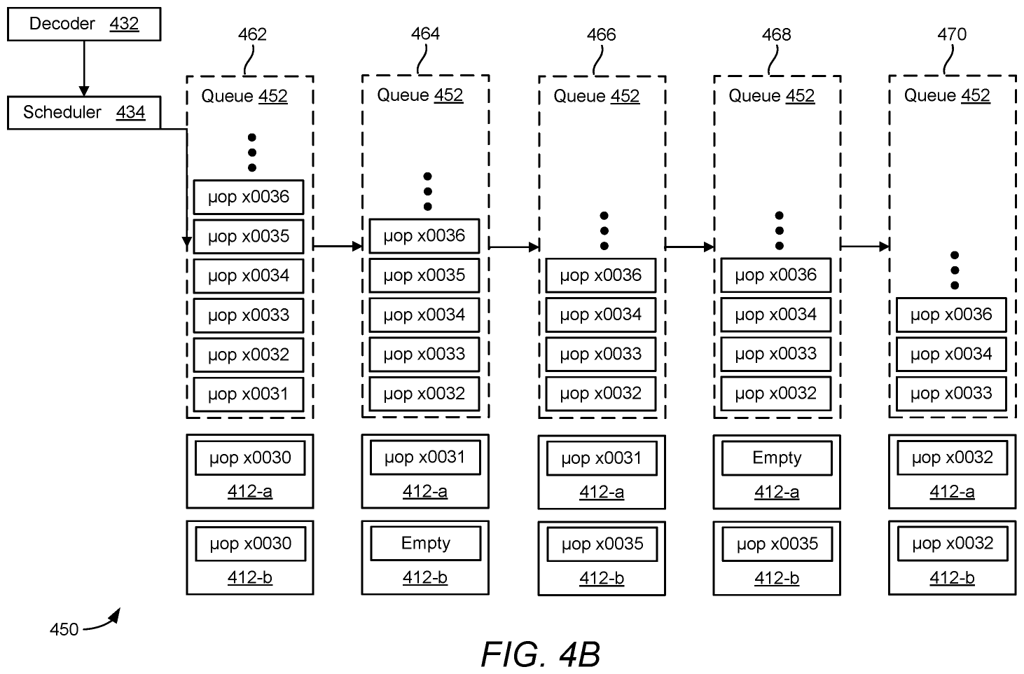

FIG. 4A illustrates an example micro-operations processing apparatus 400 including n-bit execution units 412 that perform micro-operations in a processing unit, according to aspects of the disclosure. In some examples, the techniques for performing non-vector operations on vector hardware described herein may be implemented using the micro-operations processing apparatus 400. In some examples, the techniques for performing multiple-sized vector operations on vector hardware described herein may be implemented using the micro-operations processing apparatus 400. Various elements and aspects described with respect to micro-operations processing apparatus 400 may be implemented in various processing units. For example, the n-bit execution units 412 in micro-operations processing apparatus 400 may be implemented in at least some of the one or more execution units 106 described with respect to processing unit 100-a in FIG. 1A or processing unit 100-b in FIG. 1B. Additionally, or alternatively, the n-bit execution units 412 in micro-operations processing apparatus 400 may be implemented in at least some of the one or more execution units 116 described with respect to processing unit 100-b in FIG. 1B.

In some examples, the n-bit execution units 412 in micro-operations processing apparatus 400 may be implemented in the FSU 206-a in FIG. 2A or the FSU 306-a in FIG. 3. Additionally, micro-operations processing apparatus 400 may include at least some of the one or more execution units 106 described with respect to processing unit 100-a in FIG. 1A or processing unit 100-b in FIG. 1B. Various aspects described with respect to the example hardware configuration 200 and example hardware configuration 300 may be applicable to micro-operations processing apparatus 400.

As illustrated in the example of FIG. 4A, the micro-operations processing apparatus 400 may be configured to execute one or more micro-operations. That is, for example, instructions may be forwarded to a decoder 432. The instructions may be associated with various instruction categories of an instruction set architecture (ISA), which in some examples may be an ARM ISA. In some cases, the instruction categories may include A64 Basic, advanced single instruction, multiple data (AdvSIMD), and scalable vector extension (SVE). For example, instructions in the AdvSIMD category may include floating point instructions, vectorized floating point instructions, and integer vectorized instructions. Instructions in the SVE category may include vector instructions, such as vector divide instructions. Additionally, or alternatively, certain instructions may use lower bit widths. For example, artificial intelligence (AI) instructions may use lower bit width vector instructions that require less precision than other vector instructions. As such, these lower bit width instructions may be implemented simultaneous using micro-operations processing apparatus 400, in accordance with some implementations. The decoder 432 of micro-operations processing apparatus 400 may be an IDR unit and receive and process instructions in these and other instruction set categories in accordance with various implementations.

In some examples, the decoder 432 may decode each of the received instructions into one or more micro-operations. The decoder 432 may then forward the micro-operations to a scheduler 434. The scheduler 434 may schedule and manage micro-operations for the first n-bit execution unit 412-a and the second execution unit 412-b. That is, for example, the first n-bit execution unit 412-a and the second execution unit 412-b together may form a vector micro-operation execution unit. Some of the micro-operations may be characterized as long latency micro-operations including, for example, requiring between 16 to 64 clock cycles to complete processing. In some examples, these long latency micro-operations may be non-vector micro-operations, including but not limited to scalar divide micro-operations and square root micro-operations.

The scheduler 434 may access memory including various registers, such as a first busy bit register 422-a, a second busy bit register 442-b, a first destination register 424-a, a second destination register 424-b, a first reorder buffer identifier (RobID) register 426-a, and a second RobID register 426-b. Scheduler 434 may access (e.g., control, read from, write to, and/or store in) the registers, the first n-bit execution unit 412-a, and the second execution unit 412-b via a set of lanes of the micro-operations processing apparatus 400. Additionally, the micro-operations processing apparatus 400 may include various traces or lines that may be used for control or communication between the scheduler 434 and other elements and components of micro-operations processing apparatus 400.

For example, the micro-operations processing apparatus 400 may include a first data input lane 410-a that is configured to receive a first n-bit data element. The first n-bit data element may be denoted as data sources [n−1:0]. In some non-limiting examples, the first n-bit data element may be a 64-bit data element where the data sources [n−1:0] represents bits 0 to 63 of a 128-bit register. The micro-operations processing apparatus 400 may include a second data input lane 410-b that is configured to receive a second n-bit data element. The second n-bit data element may be denoted as data sources [2n−1:n]. In some non-limiting examples, the second n-bit data element may be a 64-bit data element where the data sources [2n−1:n] represents bits 64 to 127 of the 128-bit register. Although other aspects illustrated in the figures have shown the first and second data elements both being n-bits, the disclosed techniques also apply to implementations in which the data elements have different bid widths. That is, for example, the first n-bit data element may be a 32-bit data element and the second n-bit data element may be a 16-bit data element in some implementations. Additionally, or alternatively, the disclosed techniques also apply to implementations in which more than two execution units are combined to operate with the first and second data elements both being n-bits as well as the data elements having different bid widths.

The first data input lane 410-a and the second data input lane 410-b provide input data to the first n-bit execution unit 412-a and the second n-bit execution unit 412-b in accordance with various micro-operation processes. The micro-operations processing apparatus 400 may include a first data output lane 410-c and a second data output lane 410-d. The first data output lane 410-c and the second data output lane 410-d may provide output data from the first n-bit execution unit 412-a and the second n-bit execution unit 412-b in accordance with various micro-operation processes. That is, for example, the first data output lane 410-c may be configured to provide first result data and the second data output lane 410-d may be configured to provide second result data. In some non-limiting examples, the first result data may be a 64-bit data result where the data result [n−1:0] represents bits 0 to 63 of a 128-bit register, and, the second result data may be a 64-bit data result where the data result [2n−1:n] represents bits 64 to 127 of the 128-bit register.

The micro-operations processing apparatus 400 may also include a first multiplexer 414. The first data input lane 410-a may be coupled to the input of the first n-bit execution unit 412-a. The first data input lane 410-a may also be coupled to a first input of the first multiplexer 414 via lane portion 410-e. The second data input lane 410-b may be coupled to a second input of the first multiplexer 414. An output of the first multiplexer 414 may be coupled to the input of the second n-bit execution unit 412-b via lane portion 410-f. In some examples, the micro-operations processing apparatus 400 may also include a second multiplexer 416 and a gate 418. The output of the first n-bit execution unit 412-a may be coupled to a first input of the second multiplexer 416 via lane portion 410-g. The output of the second n-bit execution unit 412-b may be coupled to a first input of the gate 418 via lane portion 410-h. The output of the second n-bit execution unit 412-b may also be coupled to a second input of the second multiplexer 416 via lane portion 410-i. The gate 418 may also include a second control input 420 that may be set based on whether the micro-operations processing apparatus 400 is operating in a vector operation mode or a non-vector operation mode. In some examples, these operation modes may be a first bit width operation mode and a second bit width operation mode, for example, when implementing multiple-sized vector micro-operations. The output of the second multiplexer 416 may be coupled to the first data output lane 410-c and the output of the gate 418 may be coupled to the second data output lane 410-d.

In some examples, the micro-operations processing apparatus 400 may be configured to operate in a vector operation mode or a non-vector operation mode. When operating in the vector operation mode, the output of the second n-bit execution unit 412-b may be allowed to pass through the gate 418 to the second data output lane 410-d. When operating in the non-vector operation mode, the output of the second n-bit execution unit 412-b may be driven to a known state and/or blocked from passing through the gate 418 to the second data output lane 410-d. It is to be appreciated that the gate 418 may be an AND gate as illustrated in the example of FIG. 4A. In such implementations, the second control input 420 may be set high (e.g., 1) when operating in the vector operation mode, or set low (e.g., 0) when operating in the non-vector operation mode. Other gates and/or switch circuitry may be utilized in various implementations. Likewise, the first multiplexer 414 and second multiplexer 416 may additionally or alternatively include other logic circuitry for mapping and/or controlling bits to the output of the corresponding multiplexer, for example, when operating in the vector operation mode or the non-vector operation mode.

In some examples, the scheduler 434 of the micro-operations processing apparatus 400 may schedule vector and non-vector micro-operations and control various aspects or the micro-operations processing apparatus 400. For example, the scheduler 434 may control and communicate with the first n-bit execution unit 412-a and the second n-bit execution unit 412-b. In some cases, the scheduler 434 may set a busy bit in a first busy bit register 422-a or a second busy bit register 442-b. The scheduler 434 may apply a data result value corresponding to a data result of one or both of the first n-bit execution unit 412-a and the second n-bit execution unit 412-b to the first destination register 424-a and/or the second destination register 424-b. Additionally, the scheduler 434 may store a RobID in the first RobID register 426-a or the second RobID register 426-b. The RobID may correspond to a particular micro-operation being performed by one or both of the first n-bit execution unit 412-a and the second n-bit execution unit 412-b.

In accordance with some aspects, the micro-operations processing apparatus 400 may be configured to handle vector micro-operations that have a data element length of 2n-bits (e.g., simultaneously using both the first n-bit execution unit 412-a and the second n-bit execution unit 412-b). That is, for example, the first n-bit execution unit 412-a and the second n-bit execution unit 412-b may cooperatively execute the vector micro-operations. The micro-operations processing apparatus 400 may also be configured to handle non-vector micro-operations that have an n-bit bit length (e.g., using the first n-bit execution unit 412-a for a first non-vector micro-operation and, in some cases, the second n-bit execution unit 412-b for a second non-vector micro-operation). In some examples, the first n-bit execution unit 412-a and the second n-bit execution unit 412-b, as well as other components of micro-operations processing apparatus 400 may operate according to a clocking system (e.g., processing each micro-operation during one or more clock cycles).

FIG. 4B illustrates an example scheduling procedure 450 associated with n-bit execution units 412 in a processing unit, according to aspects of the disclosure. Referring to the examples of FIGS. 4A and 4B, when the first scheduler 434 receives micro-operations from the decoder 432, the scheduler 434 may queue the micro-operations before sending them to the first n-bit execution unit 412-a and/or the second n-bit execution unit 412-b for processing. In some cases, the scheduler 434 queues the received micro-operations and sends them to the first n-bit execution unit 412-a and the second n-bit execution unit 412-b for processing in a FIFO manner. In some cases, the scheduler 434 may schedule micro-operations out of order (e.g., different from the FIFO order). That is, for example, based at least in part on a type of micro-operation (e.g., a vector micro-operation or a non-vector micro-operation) currently being processed by the first n-bit execution unit 412-a and/or the second n-bit execution unit 412-b as well as the type of micro-operation next in the queue 452, the scheduler 434 may select a next micro-operation in the queue 452 for processing in a FIFO manner or may select a micro-operation in the queue 452 different from the next micro-operation in the queue 452.

For example, the scheduler 434 may schedule a vector micro-operation, μop x0030 for the first n-bit execution unit 412-a and the second n-bit execution unit 412-b. That is, for example, the scheduler 434 may apply a first n-bit data element [n−1:0] of a 2n data source element for the vector pop x0030 to the first data input lane 410-a. The scheduler 434 may apply a second n-bit data element [2n−1:n] of the 2n data source element for the vector μop x0030 to the second data input lane 410-b, and the first n-bit execution unit 412-a and the second n-bit execution unit 412-b may cooperatively execute the vector μop x0030. In some examples, the scheduler 434 may configure the first multiplexer 414 such that the second n-bit data element [2n−1:n] passes from the second input of the first multiplexer 414 to the output of the first multiplexer 414 and to the second n-bit execution unit 412-b.

For example, at 462, the first n-bit execution unit 412-a and the second n-bit execution unit 412-b may perform operations on the 2n data source element for the vector μop x0030 for a first number of clock cycles. The scheduler 434 also has a queue 452 including μop x0031, μop x0032, μop x0033, μop x0034, μop x0035, and μop x0036. For example, μop x0031 may be a non-vector micro-operation associated with a scalar divide instruction, μop x0032 may be a vector micro-operation associated with a vector divide instruction, μop x0033 may also be a vector micro-operation associated with a vector divide instruction, μop x0034 may be a vector micro-operation associated with a vector floating point instruction, μop x0035 may be another non-vector micro-operation associated with a scalar divide instruction, and μop x0036 may be another vector micro-operation associated with a vector divide instruction. In some examples, one or more micro-operations (e.g., a non-vector micro-operation, such as μop x0035) to be scheduled by scheduler 434 may have been forwarded from another execution unit (e.g., IXU 306-b) of a core processor (e.g., core 102) or a processing unit (e.g., 100-a or 100-b).

The first n-bit execution unit 412-a and the second n-bit execution unit 412-b may perform operations on the 2n data source element for the vector pop x0030 during the first number of clock cycles. The scheduler 434 may configure the second multiplexer 416 (or the second multiplexer 416 may be configured) such that first result data [n−1:0] from the first n-bit execution unit 412-a passes from the first input of the second multiplexer 416 to the output of the second multiplexer 416. The first result data [n−1:0] may then pass to the first data output lane 410-c.

Additionally, the scheduler 434 may set the second control input 420 of the gate 418 to the vector operation mode such that second result data [2n−1:n] from the second n-bit execution unit 412-a passes from the first input of the gate 418 to the output of the gate 418. The second result data may then pass to the second data output lane 410-d. The scheduler 434 may then store the first and second result data [2n−1:0] to the first destination register 424-a. After the completion of the vector μop x0030, the scheduler 434 may start a next micro-operation in its queue based on a FIFO manner. That is, for example, because a vector micro-operation just completed (e.g., vector μop x0030), the scheduler 434 knows that both the first n-bit execution unit 412-a and the second n-bit execution unit 412-b are available to use for a next micro-operation. Accordingly, the scheduler 434 may schedule the next micro-operation in queue, whether the next micro-operation is a vector micro-operation or a non-vector micro-operation.

For example, at 464, the next micro-operation is non-vector μop x0031, and the scheduler 434 may schedule μop x0031 for the first n-bit execution unit 412-a and the second n-bit execution unit 412-b may remain empty, inactive, or unassigned for at least one (e.g., an initial) clock cycle when the non-vector μop x0031 is started using the first n-bit execution unit 412-a. In some cases, the non-vector μop x0031 may have a n-bit data element size. The scheduler 434 may apply the n-bit data element of non-vector pop x0031 to the first data input lane 410-a. The scheduler 434 may also apply a null data element to the second data input lane 410-b or otherwise indicate for the first multiplexer 414 to ignore the second data input lane 410-b during a current clock cycle, for example. In some cases, the scheduler 434 may configure or control the first multiplexer 414 such that the null data element from the second data input lane passes to the output of the first multiplexer 414.

Additionally, the scheduler 434 may configure or instruct the second multiplexer 416 such that first result data [n−1:0] from the first n-bit execution unit 412-a passes from the first input of the second multiplexer 416 to the output of the second multiplexer 416. The first result data [n−1:0] may then pass to the first data output lane 410-c upon completion of non-vector μop x0031 by the first n-bit execution unit 412-a after a second number of clock cycles. The scheduler 434 may also set the second control input 420 of the gate 418 to the non-vector operation mode so that null data is passed from the output of the gate 418 to the second data output lane 410-d while the micro-operations processing apparatus 400 is operating in the non-vector operation mode. Additionally, the scheduler 434 may store the first result data [n−1:0] of non-vector μop x0031 to the first destination register 424-a.

In some cases, for example, if the μop x0031 is a short latency micro-operation (e.g., 4 to 16 clock cycles corresponding to the second number of clock cycles) and/or based on other conditions, the scheduler 434 may wait until non-vector μop x0031 has completed before starting a next micro-operation in queue. In such cases, the micro-operations processing apparatus 400 may realize a savings in power consumption by temporarily not powering or using the second n-bit execution unit 412-b during this time frame. That is, for example, if a 2n-bit vector hardware design different from micro-operations processing apparatus 400 were to process a non-vector micro-operation, all execution units in the vector hardware design would typically be active while processing the non-vector micro-operation.

In some cases, for example, if the non-vector μop x0031 is either a short latency micro-operation or a long latency micro-operation (e.g., 16 to 64 clock cycles corresponding to the second number of clock cycles) and/or based on other conditions, the scheduler 434 may schedule a second non-vector micro-operation for the second n-bit execution unit 412-b. In such cases, the second non-vector micro-operation need not be the next micro-operation in the queue 452 of the scheduler 434. That is, for example, while processing the non-vector μop x0031, the next five micro-operations in the queue 452 may be vector μop x0032, vector μop x0033, vector μop x0034, non-vector μop x0035, and vector μop x0036.

As shown in FIG. 4B, at 466, the scheduler 434 may schedule non-vector μop x0035 for the second n-bit execution unit 412-b while the first n-bit execution unit 412-a is processing μop x0031 in accordance with some examples. That is, for example, non-vector μop x0035 is scheduled even though the next micro-operation in the queue 452 (according to a FIFO scheme) is vector μop x0032. In the example of FIG. 4A, the micro-operations processing apparatus 400 may not start/input or complete/output two non-vector micro-operations at the same time. That is, in the non-vector operating mode, the first data input lane 410-a is utilized for inputting or providing data elements to both the first n-bit execution unit 412-a and the second n-bit execution unit 412-b, and the first data output lane 410-c is utilized for outputting or retrieving result data from both the first n-bit execution unit 412-a and the second n-bit execution unit 412-b, as described herein. It is to be appreciated that, given the benefit of the disclosure, other micro-operations processing apparatus may be configured to allow N starting/inputting and completing/outputting two or more non-vector micro-operations simultaneously.

In some cases, the scheduler 434 may apply an n-bit data element of non-vector μop x0035 as sources [n−1:0] to the first data input lane 410-a. In some cases, the scheduler 434 may configure the first n-bit execution unit 412-a to ignore (or the first n-bit execution unit 412-a may otherwise ignore) the n-bit data element of non-vector pop x0035 currently applied to the first data input lane 410-a. That is, for example, the first n-bit execution unit 412-a may be processing the non-vector μop x0031 during the clock cycle at which the n-bit data element of non-vector μop x0035 is applied to the first data input lane 410-a. The scheduler 434 may also configure the first multiplexer 414 such that the n-bit data element of non-vector pop x0035 from the first data input lane 410-a passes to the output of the first multiplexer 414 to be received by the second n-bit execution unit 412-b via lane portion 410-f.

In some examples, at 468, the first n-bit execution unit 412-a may have completed the non-vector μop x0031 after the second number of clock cycles, and the first n-bit execution unit 412-a may be empty after the scheduler 434 retrieves the first result data [n−1:0] from the first n-bit execution unit 412-a. The scheduler 434 may configure the second multiplexer 416 (or the second multiplexer 416 may be so configured) such that result data from the second n-bit execution unit 412-b passes from the second input of the second multiplexer 416 to the output of the second multiplexer 416. The result data from the second n-bit execution unit 412-b may then pass to the first data output lane 410-c as first result [n−1:0]. Additionally, the scheduler 434 may store the first result data [n−1:0] of non-vector μop x0035 to the second destination register 424-b. At this time the scheduler 434 has a queue 452 including vector μop x0032, vector μop x0033, vector μop x0034, and vector μop x0036.

At 470, after a third number of clock cycles in which the second n-bit execution unit 212-b has completed non-vector pop x0035, the scheduler 434 may forward vector pop x0032 to the first n-bit execution unit 412-a and the second n-bit execution unit 412-b for processing. At this time the scheduler 434 has a queue 452 including vector μop x0033, vector μop x0034, and vector μop x0036. The scheduling procedure 450 may continue as vector and non-vector micro-operations are added to the queue 452 and these micro-operations are scheduled for processing by one or both of the first n-bit execution unit 412-a and the second n-bit execution unit 412-b.

In some examples, the scheduler 434 may store information in the first busy bit register 422-a, the first destination register 424-a, and the first RobID register 426-a corresponding to both the first n-bit execution unit 412-a and the second n-bit execution unit 412-b when operating in the vector operation mode. In some examples, the scheduler 434 may store information in the first busy bit register 422-a, the first destination register 424-a, and the first RobID register 426-a corresponding to the first n-bit execution unit 412-a, and information in the second busy bit register 442-b, the second destination register 424-b, and the second RobID register 426-b corresponding to the second n-bit execution unit 412-b when operating in the non-vector operation mode. That is, for example, while the first busy bit register 422-a, the first destination register 424-a, and the first RobID register 426-a may be used for either vector or non-vector micro-operations, the second busy bit register 442-b, the second destination register 424-b, and the second RobID register 426-b are used for non-vector micro-operations, in accordance with some implementations.

It is to be appreciated that while the first n-bit execution unit 412-a and the second n-bit execution unit 412-b are illustrated in the example of FIG. 4A, additional n-bit execution unit pairs 412 may be included in various implementations of a micro-operations processing apparatus given the benefit of the disclosure.

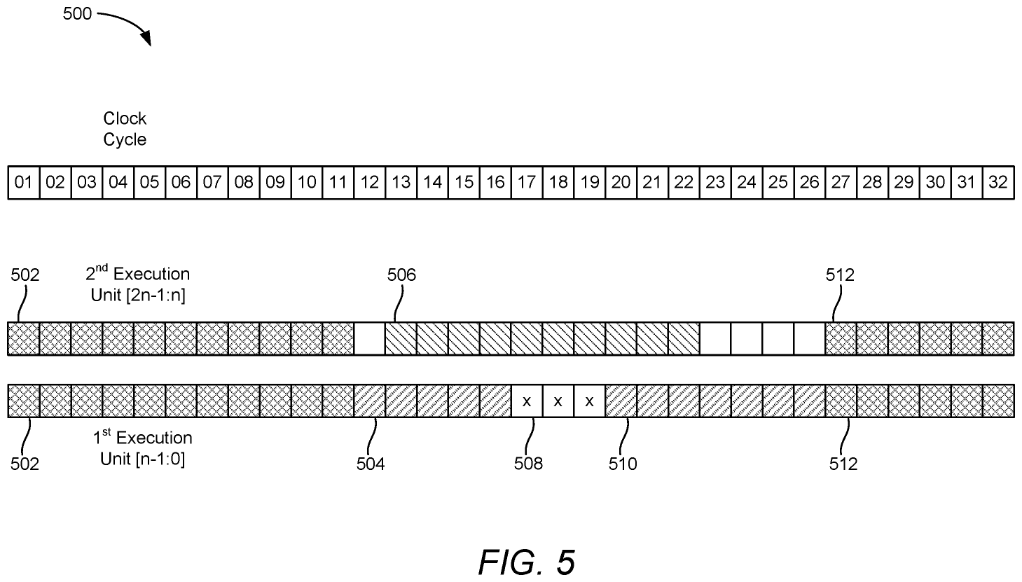

FIG. 5 is an example timing diagram 500 illustrating micro-operation processing techniques, according to aspects of the disclosure. Timing diagram 500 includes clock cycles and corresponding micro-operations that may be performed by each of a first execution unit (e.g., first n-bit execution unit 412-a) and a second execution unit (e.g., second n-bit execution unit 412-b) of a micro-operations processing apparatus (e.g., micro-operations processing apparatus 400).

In the example of FIG. 5, a first vector micro-operation may be started at time 502 during clock cycle 01. The first vector micro-operation may be processed using both the first execution unit and the second execution unit. A scheduler (e.g., scheduler 434) may store during a time period corresponding to the clock cycles (e.g., clock cycle 01 through 11) when the both the first execution unit and the second execution unit are processing the first vector micro-operation, first information, such as a busy indication, a result value, or a RobID in a first register (e.g., first busy bit register 422-a, first destination register 424-a, or first RobID register 426-a).

The first vector micro-operation may complete during clock cycle 11, and the scheduler may start a first non-vector micro-operation (or, in some implementations, a vector micro-operation with a smaller bit width than a bit width of the first vector micro-operation) at time 504 during clock cycle 12. It is to be understood that, in some implementations, the first non-vector micro-operation need not be executing in the next clock cycle immediately after completion of the first vector micro-operation. The first non-vector micro-operation may be processed using the first execution unit. Because in some implementations two non-vector micro-operations do not start or end at the same time, the scheduler may start a second non-vector micro-operation at time 506 during clock cycle 13. The second non-vector micro-operation may be processed using the second execution unit.

The scheduler may store during a time period corresponding to the clock cycles (e.g., clock cycle 13 through 16) when the first execution unit is processing first non-vector micro-operation and the second execution unit is processing the second non-vector micro-operation, first information, such as a busy indication, a result value, or a RobID in the first register and second information, such as a busy indication, a result value, or a RobID in a second register (e.g., second busy bit register 422-b, second destination register 424-b, or second RobID register 426-b).

At time 508 during clock cycle 17, the first execution unit may experience a fault or interrupt event triggering a flush of the first non-vector micro-operation being processed by the first execution unit. The flush of the first non-vector micro-operation only affects the operation of the first execution unit, and the second non-vector micro-operation continues to be processed by the second execution unit. Accordingly, the scheduler may access a first register storing the RobID (e.g., first RobID register 426-a) corresponding to the first non-vector micro-operation being processed by the first execution unit. That is, for example, the scheduler knows that the first execution unit and the second execution unit are operating in a non-vector operation mode. Thus, the scheduler knows that the first register stores the RobID of the first non-vector micro-operation and a second register (e.g., second RobID register 426-b) stores the RobID of the second non-vector micro-operation currently being processed by each of the first and second execution units.

At time 510 during clock cycle 20, the scheduler may start a third non-vector micro-operation using the first execution unit. The second non-vector micro-operation may complete during clock cycle 22, and the scheduler may determine that the next micro-operation in a FIFO-prioritized queue is a vector micro-operation requiring both the first execution unit and the second execution unit. As such, the scheduler may wait until the third non-vector micro-operation completes during clock cycle 26 and start the second vector micro-operation at time 512 during clock cycle 27 using both the first execution unit and the second execution unit.

In the example of FIG. 5, the first vector micro-operation may have an m-bit vector data element such that the first execution unit processes a first part data element of the m-bit vector data element. In some cases, the first part data element of the m-bit may include half of the m-bits. That is, for example, the first execution unit and the second execution unit may be equally sized (e.g., the first execution unit may be a 64-bit execution unit and the second execution unit may be a 64-bit execution unit) such that 128-bit vector data elements may be processed. In some cases, the first part data element of the m-bit may include more or fewer than half of the m-bits in the vector data element. That is, for example, the first execution unit and the second execution unit may be unequally sized (e.g., the first execution unit may be a 64-bit execution unit and the second execution unit may be a 32-bit execution unit) such that 96-bit vector data elements may be processed.

Continuing with the example of FIG. 5, the first non-vector micro-operation may have an n-bit non-vector data element such that the first execution unit processes the n-bit data element. The size of the n-bit non-vector data element is less than the size of the m-bit vector data element, in accordance with some implementations. That is, for example, rather than using equally-sized vector and non-vector data elements (which may make scheduling micro-operations regardless of type simpler in some respects), by having non-vector micro-operation data elements sized for at least the first execution unit, the micro-operations processing apparatus may realize savings in power consumption (e.g., when the first execution unit is active with a non-vector micro-operation and the second execution unit is inactive) and an increase in processing speed (e.g., when the first execution unit is active with a non-vector micro-operation and the second execution unit is active with another non-vector micro-operation). For example, the first execution unit processes a portion of the first non-vector micro-operation during the clock cycles 13 through 16 while the second execution unit processes a portion of the second non-vector micro-operation, as illustrated in FIG. 5.

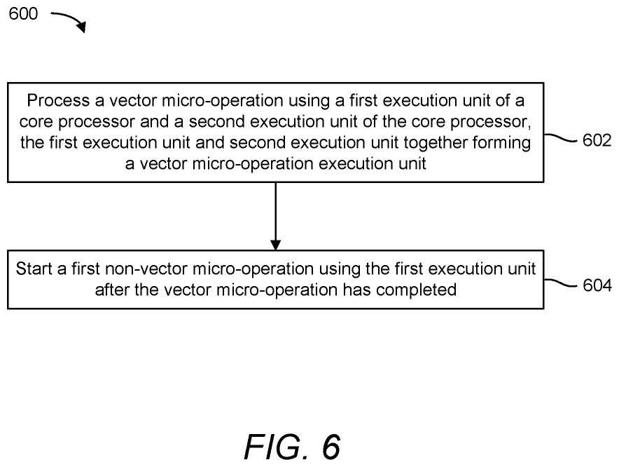

FIG. 6 is a flowchart of an example process 600 associated with techniques for performing non-vector micro-operations on vector hardware. In some implementations, one or more process blocks of FIG. 6 may be performed by a processing unit (e.g., processing unit 100-a or 100-b including micro-operations processing apparatus 400). In some implementations, one or more process blocks of FIG. 6 may be performed by another device or a group of devices separate from or including the processing unit. Additionally, or alternatively, one or more process blocks of FIG. 6 may be performed by one or more components of a processing unit, such as core processors, cache and memory, execution units, and/or interconnects.

As shown in FIG. 6, process 600 may include processing a vector micro-operation using a first execution unit of a core processor and a second execution unit of the core processor, the first execution unit and second execution unit together forming a vector micro-operation execution unit (block 602). For example, the processing unit may process a vector micro-operation using a first execution unit of a core processor and a second execution unit of the core processor, as described herein. In some cases, the first execution unit and second execution unit together may form a vector micro-operation execution unit.

As further shown in FIG. 6, process 600 may include starting a first non-vector micro-operation using the first execution unit after the vector micro-operation has completed (block 604). For example, the processing unit may start a first non-vector micro-operation on the first execution unit during a first clock cycle after the vector micro-operation has completed, as described herein.

Process 600 may include additional implementations, such as any single implementation or any combination of implementations described below and/or in connection with one or more other processes described elsewhere herein.

In a first implementation of process 600, the vector micro-operation may have an m-bit vector data element such that the first execution unit processes a first part data element of the m-bit vector data element and the second execution unit processes a second data part of the m-bit vector data element. The first non-vector micro-operation may have an n-bit data element such that the first execution unit is configured to process the n-bit data element. The m-bit vector data element may be larger than the n-bit data element.

In a third implementation, process 600 may include starting a second non-vector micro-operation using the second execution unit while the first non-vector micro-operation is being processed by the first execution unit.

In a fourth implementation of process 600, the second non-vector micro-operation may have a second data element such that the second execution unit processes the second data element. The second data element may be provided to the second execution unit via at least a portion of a same data input lane used to provide a first data element of the first non-vector micro-operation to the first execution unit.

In a fifth implementation, process 600 may include flushing the first execution unit while the second execution unit continues to process the second non-vector micro-operation, and accessing a first register storing a first reorder buffer identifier corresponding to the first non-vector micro-operation associated with the first execution unit based at least in part on the first execution unit and the second execution unit operating in a non-vector operation mode.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

Advantages of process 600 include, in some examples, reduced power consumption and/or increased throughput by performing multiple non-vector micro-operations (e.g., scalar divide micro-operations) at a time. In some implementations, a micro-operations processing apparatus configured with execution units described herein may perform scalar divide micro-operations faster than conventional IXUs, for example, by using vector hardware configurations faster than conventional IXUs and performing multiple scalar divide micro-operations at the same time.

It is to be appreciated that various techniques for performing micro-operations on vector hardware are contemplated under the disclosure. For example, differently sized vectors may be processed by a processing unit (e.g., processing unit 100-a or 100-b including micro-operations processing apparatus 400) in accordance with some implementations. That is, for example, multiple 8-bit width vectors, 32-bit width vectors, or 64-bit width vectors may be simultaneously processed by plural execution units configured for a 128-bit width standard or full bit width vector micro-operations. That is, the processing unit may additionally or alternatively process smaller bit width vector micro-operations alternatively or in addition to non-vector micro-operations.

An example process may include processing a first vector micro-operation using a first execution unit of a core processor and a second execution unit of the core processor, the first execution unit and second execution unit together forming a vector micro-operation execution unit for performing vector micro-operation having a first bit width. The process may also include starting a second vector micro-operation using the first execution unit after the vector micro-operation has completed, the second vector micro-operation having a second bit width less than the first bit width.

In some implementations, the first vector micro-operation has an m-bit vector data element of the first bit width such that the first execution unit processes a first part data element of the m-bit vector data element and the second execution unit processes a second data part of the m-bit vector data element. In some implementations, the second vector micro-operation has an n-bit data element of the second bit width such that the first execution unit is configured to process the n-bit data element.

In some examples, the process may include starting a third vector micro-operation using the second execution unit while the second vector micro-operation is being processed by the first execution unit. In some implementations, the third vector micro-operation has a second data element such that the second execution unit processes the second data element. In some implementations, the second data element is provided to the second execution unit via at least a portion of a same data input lane used to provide a first data element of the second vector micro-operation to the first execution unit.

In some examples, a micro-operation processing apparatus (e.g., micro-operations processing apparatus 400) may be used to implement techniques for performing different-sized vector micro-operations. For example, where a ‘non-vector micro-operation’ or a ‘non-vector operating mode’ is described herein, such aspects may correspond to a ‘first bit width vector micro-operation’ and a ‘first bit width vector operating mode.’

In some examples, the micro-operation processing apparatus may include a first n-bit execution unit configured to execute micro-operations and a second n-bit execution unit configured to execute micro-operations. The micro-operation processing apparatus may include a first multiplexer that has an output operatively coupled to an input of the second n-bit execution unit. The micro-operation processing apparatus may include a first data input lane operatively coupled to an input of the first n-bit execution unit and a first input of the first multiplexer. The micro-operation processing apparatus may include a second data input lane operatively coupled to a second input of the first multiplexer. In some cases, the first n-bit execution unit and the second n-bit execution unit are configured to cooperatively execute a first vector micro-operation of a first bit width. In some cases, at least one of the first n-bit execution unit or the second n-bit execution unit is configured to execute a second vector micro-operation. In some cases, the second vector micro-operation has a second bit width less than the first bit width.

In some examples, the micro-operation processing apparatus may include a second multiplexer having a first input operatively coupled to an output of the second n-bit execution unit and a second input operatively coupled to an output of the first n-bit execution unit. The micro-operation processing apparatus may include a first data output lane operatively coupled to an output of the second multiplexer and a gate having a first input operatively coupled to an output of the second n-bit execution unit and a second input associated with at least one of a first bit-width vector operation mode or a second bit width vector operation mode. The micro-operation processing apparatus may include a second data output lane operatively coupled to an output of the gate.

In some examples, the micro-operation processing apparatus may include a scheduler that is configured to schedule a first vector micro-operation for the first n-bit execution unit and the second n-bit execution unit. The scheduler may apply a first n-bit data element associated with the first vector micro-operation to the first data input lane and apply a second n-bit data element associated with the first vector micro-operation to the second data input lane. The scheduler may configure the first multiplexer such that the second n-bit data element associated with the first vector micro-operation passes from the second input of the first multiplexer to the output of the first multiplexer and to the second n-bit execution unit. The scheduler may configure the second multiplexer such that first result data from the first n-bit execution unit passes from the first input of the second multiplexer to the output of the second multiplexer and to the first data output lane. In some cases, the scheduler may set the second input of the gate to the first bit width vector operation mode such that second result data from the second n-bit execution unit passes from the first input of the gate to the output of the gate and to the second data output lane.

In some examples, the scheduler of the micro-operation processing apparatus may be configured to schedule a second vector micro-operation for the first n-bit execution unit. The scheduler may apply a first n-bit data element of the second bit width associated with the second vector operation to the first data input lane. The scheduler may apply a null data element to the second data input lane and configure the first multiplexer such that the null data element from the second data input lane passes to the output of the first multiplexer. The scheduler may configure the second multiplexer such that first result data from the first n-bit execution unit passes from the first input of the second multiplexer to the output of the second multiplexer and to the first data output lane. In some cases, the scheduler may set the second input of the gate to the second bit width vector operation mode such that no data is passed from the output of the gate to the second data output lane.

In some examples, the scheduler of the micro-operation processing apparatus may be configured to schedule a third vector micro-operation for the second n-bit execution unit. The scheduler may apply a second n-bit data element of the second bit width associated with the third vector micro-operation to the first data input lane and configure the first n-bit execution unit to ignore the second n-bit data element associated with the third vector micro-operation. The scheduler may configure the first multiplexer such that the second n-bit data element from the first data input lane passes to the output of the first multiplexer and configure the second multiplexer such that second result data from the second n-bit execution unit passes from the second input of the second multiplexer to the output of the second multiplexer and to the first data output lane.

In some examples, the micro-operation processing apparatus may include one or more registers configured to store information associated with the first n-bit execution unit, the second n-bit execution unit, or both. In some cases, the scheduler may be configured to store, based at least in part on the first bit width vector operation mode, first information in a first register of the one or more registers associated with both the first n-bit execution unit and the second n-bit execution unit. In some cases, the first information in the first register corresponds to at least one of a busy indication, a result value, or a reorder buffer identifier. In some cases, the scheduler may be configured to store, based at least in part on the second bit width vector operation mode, first information in the first register of the one or more registers associated with the first n-bit execution unit. The scheduler may also store, based at least in part on the second bit width vector operation mode, second information in a second register of the one or more registers associated with the second n-bit execution unit.

In some examples, the scheduler of the micro-operation processing apparatus may be configured to determine a next micro-operation in a first-in first-out queue for the vector micro-operations. The scheduler may schedule, when operating in the first bit width vector operation mode, the next vector micro-operation for processing by the first n-bit execution unit, the second n-bit execution unit, or both. In some examples, the scheduler may schedule, when operating in the second bit width vector operation mode and the next micro-operation is a vector micro-operation associated with the first bit width, a vector micro-operation associated with a second bit width queued after the next micro-operation for processing by one of the first n-bit execution unit or the second n-bit execution unit.

In some cases, the first n-bit execution unit may be scheduled to execute a first vector micro-operation associated with the second bit width and the second n-bit execution unit may be scheduled to execute a second vector micro-operation associated with the second bit width. In some cases, the first n-bit execution unit may process at least a portion of the first vector micro-operation during a clock cycle and the second n-bit execution unit processes at least a portion of the second vector micro-operation during the clock cycle.

In some examples, each of the first n-bit execution unit and the second n-bit execution unit are configured to execute a corresponding vector micro-operation having the second bit width.

In one or more example aspects, the functions described may be implemented in hardware, software, firmware, or any combination thereof.

Those of skill in the art will appreciate that information and signals may be represented using any of a variety of different technologies and techniques. Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects described herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium, including but not limited to, computer readable medium or non-transitory storage media known in the art. An example storage medium may be coupled to the processor such that the processor can read information from, and write information to, the storage medium. In the alternative, the storage medium may be integral to the processor. The processor and the storage medium may reside in an ASIC.

Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A micro-operation processing apparatus, comprising:
a first execution unit configured to execute micro-operations;
a second execution unit configured to execute micro-operations;
a first multiplexer having an output operatively coupled to an input of the second execution unit;
a first data input lane operatively coupled to an input of the first execution unit and a first input of the first multiplexer; and
a second data input lane operatively coupled to a second input of the first multiplexer, wherein the first execution unit and the second execution unit are configured to cooperatively execute a vector micro-operation and at least one of the first execution unit or the second execution unit is configured to execute a non-vector micro-operation.

2. The micro-operation processing apparatus of claim 1, further comprising:
a second multiplexer having a first input operatively coupled to an output of the second execution unit and a second input operatively coupled to an output of the first execution unit;
a first data output lane operatively coupled to an output of the second multiplexer;
a gate having a first input operatively coupled to an output of the second execution unit and a second input associated with at least one of a vector operation mode or a non-vector operation mode; and
a second data output lane operatively coupled to an output of the gate.

3. The micro-operation processing apparatus of claim 2, further comprising:
a scheduler configured to:
schedule a vector micro-operation for the first execution unit and the second execution unit;
apply a first data element associated with the vector micro-operation to the first data input lane;
apply a second data element associated with the vector micro-operation to the second data input lane;
configure the first multiplexer such that the second data element associated with the vector micro-operation passes from the second input of the first multiplexer to the output of the first multiplexer and to the second execution unit;
configure the second multiplexer such that first result data from the first execution unit passes from the first input of the second multiplexer to the output of the second multiplexer and to the first data output lane; and
set the second input of the gate to the vector operation mode such that second result data from the second execution unit passes from the first input of the gate to the output of the gate and to the second data output lane.

4. The micro-operation processing apparatus of claim 2, further comprising:
a scheduler configured to:
schedule a first non-vector micro-operation for the first execution unit;
apply a first data element associated with the first non-vector operation to the first data input lane;
apply a null data element to the second data input lane;
configure the first multiplexer such that the null data element from the second data input lane passes to the output of the first multiplexer;
configure the second multiplexer such that first result data from the first execution unit passes from the first input of the second multiplexer to the output of the second multiplexer and to the first data output lane; and
set the second input of the gate to the non-vector operation mode such that no data is passed from the output of the gate to the second data output lane.

5. The micro-operation processing apparatus of claim 4, wherein the scheduler is further configured to:
schedule a second non-vector micro-operation for the second execution unit;
apply a second data element associated with the second non-vector micro-operation to the first data input lane;
configure the first execution unit to ignore the second data element associated with the second non-vector micro-operation;
configure the first multiplexer such that the second data element from the first data input lane passes to the output of the first multiplexer;
configure the second multiplexer such that second result data from the second execution unit passes from the second input of the second multiplexer to the output of the second multiplexer and to the first data output lane;
apply the first data element to the first data input lane during a first clock cycle;
apply the second data element to the first data input lane a second clock cycle different from the first clock cycle;
configure the second multiplexer such that the first result data passes from the second input of the second multiplexer to the output of the second multiplexer during a third clock cycle; and
configure the second multiplexer such that the second result data passes from the second input of the second multiplexer to the output of the second multiplexer during a fourth clock cycle different from the third clock cycle.

6. The micro-operation processing apparatus of claim 1, further comprising:
one or more registers configured to store information associated with the first execution unit, the second execution unit, or both; and
a scheduler configured to:
store during a first time period, based at least in part on a vector operation mode, first information in a first register of the one or more registers associated with both the first execution unit and the second execution unit;
store during a second time period different from the first time period, based at least in part on a non-vector operation mode, second information in the first register of the one or more registers associated with the first execution unit; and
store during the second time period, based at least in part on the non-vector operation mode, third information in a second register of the one or more registers associated with the second execution unit.

7. The micro-operation processing apparatus of claim 6, wherein at least one of the first information, the second information, or the third information corresponds to at least one of a busy indication, a result value, or a reorder buffer identifier.

8. The micro-operation processing apparatus of claim 1, further comprising:
a scheduler configured to:
determine a next micro-operation in a first-in first-out queue for vector and non-vector micro-operations; and
schedule, when operating in a vector operation mode, the next micro-operation for processing by the first execution unit, the second execution unit, or both.

9. The micro-operation processing apparatus of claim 1, further comprising:
a scheduler configured to:
determine a next micro-operation in a first-in first-out queue for vector and non-vector operations; and
schedule, when operating in a non-vector operation mode and the next micro-operation is a vector micro-operation, a non-vector micro-operation queued after the next micro-operation for processing by one of the first execution unit or the second execution unit.

10. The micro-operation processing apparatus of claim 1, wherein:
the first execution unit is scheduled to execute a first non-vector micro-operation and the second execution unit is scheduled to execute a second non-vector micro-operation; and
the first execution unit processes at least a portion of the first non-vector micro-operation during a clock cycle and the second execution unit processes at least a portion of the second non-vector micro-operation during the clock cycle.

11. The micro-operation processing apparatus of claim 1, wherein each of the first execution unit and the second execution unit are configured to execute a corresponding non-vector micro-operation.

12. A method comprising:
processing a vector micro-operation using a first execution unit of a core processor and a second execution unit of the core processor, the first execution unit and second execution unit together forming a vector micro-operation execution unit; and
starting a first non-vector micro-operation using the first execution unit after the vector micro-operation has completed.

13. The method of claim 12, wherein:
the vector micro-operation has an m-bit vector data element such that the first execution unit processes a first part data element of the m-bit vector data element and the second execution unit processes a second data part of the m-bit vector data element;
the first non-vector micro-operation has an n-bit data element such that the first execution unit is configured to process the n-bit data element; and
the m-bit vector data element is larger than the n-bit data element.

14. The method of claim 12, further comprising:
starting a second non-vector micro-operation using the second execution unit while the first non-vector micro-operation is being processed by the first execution unit.

15. The method of claim 14, wherein:
the second non-vector micro-operation has a second data element such that the second execution unit processes the second data element; and
the second data element is provided to the second execution unit via at least a portion of a same data input lane used to provide a first data element of the first non-vector micro-operation to the first execution unit.

16. The method of claim 14, further comprising:
flushing the first execution unit while the second execution unit continues to process the second non-vector micro-operation; and
accessing a first register storing a first reorder buffer identifier corresponding to the first non-vector micro-operation associated with the first execution unit based at least in part on the first execution unit and the second execution unit operating in a non-vector operation mode.

17. A processing unit, comprising:
one or more memories; and
one or more processors communicatively coupled to the one or more memories, the one or more processors, either alone or in combination, configured to:
process a vector micro-operation using a first execution unit of a core processor and a second execution unit of the core processor, the first execution unit and second execution unit together forming a vector micro-operation execution unit; and
start a first non-vector micro-operation using the first execution unit after the vector micro-operation has completed.

18. The processing unit of claim 17, wherein:
the vector micro-operation has an m-bit vector data element such that the first execution unit processes a first part data element of the m-bit vector data element and the second execution unit processes a second data part of the m-bit vector data element;
the first non-vector micro-operation has an n-bit data element such that the first execution unit is configured to process the n-bit data element; and
the m-bit vector data element is larger than the n-bit data element.

19. The processing unit of claim 17, wherein the one or more processors, either alone or in combination, are further configured to:
start a second non-vector micro-operation using the second execution unit while the first non-vector micro-operation is being processed by the first execution unit.

20. The processing unit of claim 19, wherein:
the second non-vector micro-operation has a second data element such that the second execution unit processes the second data element; and
the second data element is provided to the second execution unit via at least a portion of a same data input lane used to provide a first data element of the first non-vector micro-operation to the first execution unit.
